(19) United States
(12) Patent Application Publication
(10) Pub. No.: US 2025/0119430 A1
(43) Pub. Date: Apr. 10, 2025

(54) SYSTEMS AND METHODS FOR SECURING CONTENT

(71) Applicant: Capital One Services, LLC, McLean, VA (US)

(72) Inventors: Matthew HUNSBERGER, Hoboken, NJ (US); Tyler MAIMAN, Melville, NY (US); Joshua EDWARDS, Philadelphia, PA (US); Ian KATZMAN, Herndon, VA (US); Shahalam BAIG, Rochester, NY (US); Jackson WESTWOOD, New York, NY (US); Shasanka BHANDARI, McLean, VA (US)

(73) Assignee: Capital One Services, LLC, McLean, VA (US)

(21) Appl. No.: 18/905,169

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. H04L 9/40

(52) U.S. Cl. CPC H04L 63/10

(57) ABSTRACT

A method may include determining, using a browser module of a computing device, whether a content element representing a first portion of a webpage includes sensitive information. The computing device may include a secure display path. The method may include determining, using the browser module, whether the secure display path is enabled in response to determining that the content element includes the sensitive information. The method may include outputting, using the browser module, the content element to a display screen associated with the computing device via the secure display path, in response to determining that the secure display path is enabled. The method may further include outputting, using the browser module, a second portion of the webpage to the display screen associated with the computing device.

### CROSS-REFERENCE TO RELATED APPLICATIONS

This application claims the benefit of pending U.S. Provisional Patent Application No. 63/587,891, filed on Oct. 4, 2023, pending U.S. Provisional Patent Application No. 63/665,485, filed on Jun. 28, 2024, and pending U.S. Provisional Patent Application No. 63/683,063, filed on Aug. 14, 2024, each of which is incorporated herein by reference in its entirety.

### TECHNICAL FIELD

Various embodiments of this disclosure relate generally to techniques for securing content, and more particularly to systems and methods for securing content of a portal (e.g., a webpage, a website, etc.) displayed on a display screen.

### BACKGROUND

Organizations such as banks and healthcare providers seek to protect sensitive information (e.g., confidential information, personally identifiable information, financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, when the target is a user who uses a display screen (also referred to herein as a “screen”) of a computing device to view an account number on a bank's website, a social engineer using another computing device may attempt to persuade the user to reveal the account number to the social engineer. More specifically, the social engineer may convince the user to share the user's screen displaying the account number with the social engineer, using a screensharing or remote desktop application. In addition or in the alternative, the social engineer may convince the user to take a screenshot of the user's screen displaying the account number, using a screenshotting application, and then transmit the screenshot to the social engineer.

To guard against such social engineering, the bank may employ digital rights management (DRM) technologies, which are technologies that limit the use of digital content. However, the DRM technologies may cause delays in loading, rendering, or presenting the bank's website on the display screen.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for securing content of a portal (e.g., a webpage, a website, etc.) displayed on a display screen are disclosed. Each of the examples disclosed herein may include one or more features described in connection with any of the other disclosed examples.

In one aspect, an exemplary embodiment of a method may include determining, using a browser module of a computing device, whether a content element representing a first portion of a webpage includes sensitive information. The computing device may include a secure display path. The method may include determining, using the browser module, whether the secure display path is enabled in response to determining that the content element includes the sensitive information. The method may include outputting, using the browser module, the content element to a display screen associated with the computing device via the secure display path, in response to determining that the secure display path is enabled. The method may further include outputting, using the browser module, a second portion of the webpage to the display screen associated with the computing device.

In a further aspect, an exemplary embodiment of a system may include a processor and a memory having programming instructions stored thereon, which, when executed by the processor, causes the system to perform operations. The operations may include determining, using a browser module of a computing device, whether a content element representing a first portion of a webpage includes sensitive information. The computing device includes a secure display path. The operations may include determining, using the browser module, whether the secure display path is enabled in response to determining that the content element includes the sensitive information. The operations may include outputting, using the browser module, the content element to a display screen associated with the computing device via the secure display path, in response to determining that the secure display path is enabled. The operations may further include outputting, using the browser module, a second portion of the webpage to the display screen associated with the computing device.

In another aspect, an exemplary embodiment of a method may include determining, using a browser module of a computing device, whether a content element of a first portion of a webpage is associated with a security attribute including at least one security requirement. The computing device may include a secure display path, and the security attribute may represent that the content element includes sensitive information. The method may include determining, using the browser module, whether the secure display path is enabled in response to determining that the content element is associated with the security attribute. The method may include outputting, using the browser module, the content element to a display screen associated with the computing device via the secure display path, in response to determining that the secure display path is enabled. The method may further include outputting, using the browser module, a second portion of the webpage to the display screen associated with the computing device.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment, according to one or more embodiments.

FIG. 2 depicts a flowchart of an example method, according to one or more embodiments.

FIG. 3 depicts a flowchart of an example method, according to one or more embodiments.

FIG. 4 depicts an example computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, the term “screenshare” may refer to a real time or near real time electronic transmission of data displayed on a display screen of a user's computing device to one or more other computing devices. The term “screensharing” and the phrase “being screenshared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” may represent an image of data displayed on a display screen of a computing device, where the image may be captured or recorded. The term “screenshotting” and the phrase “being screenshotted” may refer to capturing or recording a screenshot. In some aspects, screenshotting may be performed using a screenshotting application (e.g., the Snipping Tool in Microsoft's Windows 11 or an application accessed using a Print Screen key of a keyboard or keypad). As used herein, the term “alt text” (also referred to herein as “alternative text”) may refer to text configured to be identified and interpreted by a screen reader. For example, alt text may represent a short description of an image or other data. In some aspects, alt text may be included or referenced in a Hypertext Markup Language (HTML) element of an HTML page. The term “HTML page” may refer to a file that includes HTML, and that defines the structure and content of a webpage or website.

In the following description, embodiments will be described with reference to the accompanying drawings. As will be discussed in more detail below, various embodiments, methods, and systems for securing content of a portal (e.g., a webpage, a website, etc.) displayed on a display screen are described.

In an exemplary use case, a customer of a bank may use a user device (e.g., a laptop) to obtain financial information. More specifically, the customer may use a browser presented on a display screen of the user device to load a webpage that is associated with the bank, and on which the customer anticipates viewing the customer's checking account balance, for example. The customer's checking account balance may represent a first portion of the webpage.

As the webpage is loaded, the browser may determine whether the checking account balance represents sensitive information. In some aspects, sensitive information may refer to data that is intended for, or restricted to the use of, one or more users or entities (e.g., the customer and the bank). Further, sensitive information may represent data that is personal, private, confidential, privileged, secret, classified or in need of protection, for example. In response to determining that the checking account balance represents sensitive information, the browser may determine whether a secure display path of the user device is enabled. In some aspects, the secure display path may represent one or more technologies (e.g., functions) of an operating system operating on a user device that are used to protect data that is output to, and presented on, a display screen. In some embodiments, the secure display path may be enabled when the operating system supports the secure display path. In some other embodiments, the secure display path may be enabled when (i) the operating system supports the secure display path and (ii) one or more security requirements associated with the sensitive information are satisfied.

In response to determining that the secure display path is enabled, the browser may output the checking account balance (the first portion of the webpage) to the display screen of the user device via the secure display path. The browser may also output a second portion of the webpage (e.g., some or all of the remainder of webpage, which may not include sensitive information) directly to the display screen, or indirectly to the display screen via the secure display path.

In some embodiments, where the browser determines that the checking account balance (the first portion of the webpage) does not represent sensitive information, the browser may output both the first and second portions of the webpage directly to the display screen (e.g., not via the secure display path). Further, in some embodiments, where the browser determines that the user's checking account balance represents sensitive information and that the secure display path is not enabled, the browser may output the second portion of the webpage and alt text corresponding to the first portion of the webpage (but not the checking account balance) directly to the display screen (e.g., not via the secure display path).

As explained above, in embodiments where the browser outputs the checking account balance to the display screen via the secure display path (also referred to herein as a “secure media path”), the secure media path may secure the checking account balance. That is, the secure media path may protect the checking account balance from potentially be shared with a social engineer. For example, in some embodiments, where the display screen is being screenshotted or screenshared, the secure media path may be configured to block (or prevent) the checking account balance from being displayed on the display screen. As another example, in some embodiments, the secure media path may be configured to block (or prevent) the checking account balance from being transmitted to one or more external ports of the user device (e.g., a port for receiving an external storage device or a printer, etc.). As yet another example, in some embodiments, the secure media path may be configured to block (or prevent) the checking account balance from being transmitted to one or more loud speakers included in the user device. Because the checking account balance may be protected without the use of conventional digital rights management technologies (e.g., Google's Widevine or technologies involving a content decryption module), the checking account balance may be loaded, rendered, and presented on the display screen more quickly. As a result, processing resources of the user device may be conserved.

While the example above involves a webpage and checking account balance, it should be understood that techniques according to this disclosure may be adapted to any suitable type of program (e.g., a website, portal, application, browser extension, plugin, etc.) and data (e.g., text data, image data, audio data, etc.), respectively. It should also be understood that the example above is illustrative only. The techniques and technologies of this disclosure may be adapted to any suitable activity.

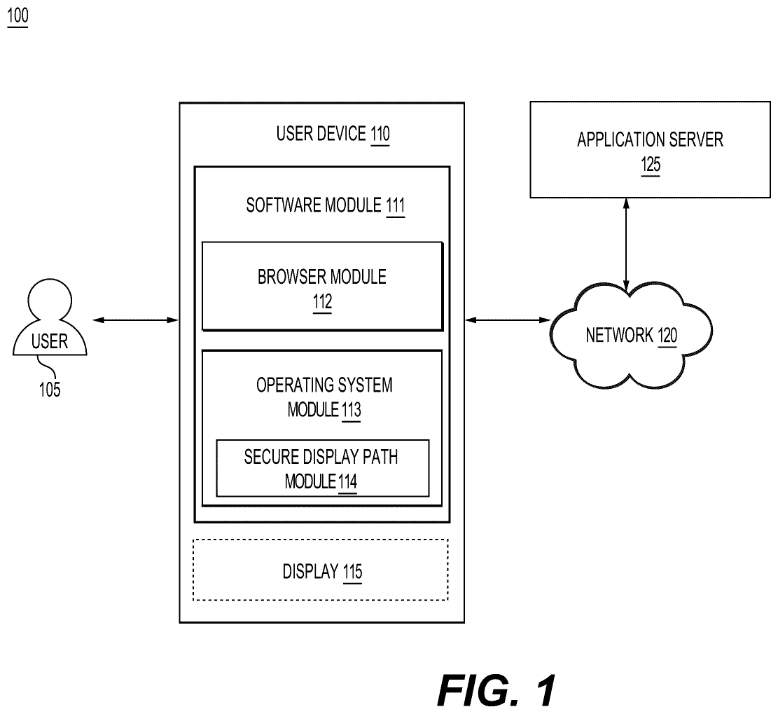

FIG. 1 depicts an example environment 100 that may be utilized with techniques presented herein. In some aspects, the environment 100 may be an embodiment of (i) the environment 100 described in U.S. Provisional Application 63/587,891, filed Oct. 4, 2023, (ii) the environment 100 described in U.S. Provisional Patent Application No. 63/665,485, filed Jun. 28, 2024, or (iii) the environment 100 described in U.S. Provisional Patent Application No. 63/683,063, filed Aug. 14, 2024, where each of these U.S. provisional applications is incorporated by reference herein in its entirety. As shown in FIG. 1, a user device 110 and an application server 125 may communicate with one another in any arrangement across a network 120 (e.g., an electronic network). The user device 110 may be associated with a user 105. In some embodiments, the user 105 may be a customer or employee of, or contractor for, a company, business, or organization (e.g., a bank, a hospital, a university, etc.), or the like. Further, in some embodiments, the company, business, or organization may be associated with (e.g., own, rent, or control) the user device 110. In some other embodiments, the user 105 may own, rent, or control the user device 110.

The user device 110 may be configured to enable the user 105 to access or interact with the network 120 and the application server 125 in the environment 100. For example, the user device 110 may be a computer system such as a desktop computer, a laptop, a workstation, a mobile device, a tablet, etc. In some embodiments, the user device 110 may include one or more software modules, which may represent electronic application(s) such as a program, a platform, a plugin, or a browser extension, installed on a memory of the user device 110. For example, as shown in FIG. 1, the user device 110 may include a software module 111 that may represent (or include), for example, a browser module 112 and an operating system module 113. The user device 110 may also include a display 115 (e.g., a display screen configured to display or present data received from the browser module 112 directly or indirectly via a secure display path module 114). In some embodiments, the user device 110 may be configured to perform methods described in this disclosure.

The browser module 112 may include one or more browsers (e.g., web browsers or applications for accessing and viewing content on the internet, the World Wide Web, a cloud platform, etc.). In some embodiments, the browser module 112 may be configured to communicate with the operating system module 113, the display 115, the network 120, and the application server 125 via the network 120. For example, in response to the user 105 inputting a web address (or uniform resource locator) to the browser module 112 (e.g., using the display 115 and a keyboard associated with the user device 110), the browser module 112 may be configured to transmit a request for a webpage (or website, portal, web application, etc.) associated with the web address, to the application server 125 via the network 120. The browser module 112 may also be configured to receive the webpage from the application server 125 via the network 120.

In some embodiments, the browser module 112 may be configured to determine whether one or more content elements representing a first portion of the webpage include sensitive information. In some aspects, a content element may represent data such as text data (e.g., letters, numbers, symbols, metadata, or alt text), image data (e.g., an image, a graphic, a sequence of image frames, or a video), or audio data (e.g., a sequence of audio frames). Further, a content element may represent data included in, or referred by, an HTML element of an HTML page corresponding to (or representing) the webpage. An HTML element may represent a component of an HTML page, and may include, for example, a start tag and end tag, and as noted above, a content element or a reference to a content element (e.g., link, hyperlink, address, or path to a content element). Further, in some embodiments, an HTML element may include one or more HTML elements (e.g., nested HTML elements). As explained above, sensitive information may refer to data that is intended for, or restricted to the use of, one or more users or entities (e.g., the user 105 and an organization associated with the application server 125). Moreover, sensitive information may represent data that is personal, private, confidential, privileged, secret, classified, or in need of protection, for example.

In some embodiments, to determine whether the one or more content elements representing the first portion of the webpage include sensitive information, the browser module 112 may be configured to scan (e.g., analyze or process) the HTML page corresponding to the webpage to identify any HTML elements included in the HTML page that are tagged (e.g., marked or flagged) as including sensitive information. In addition or in the alternative, the browser module 112 may be configured to scan (e.g., analyze or process) the HTML page corresponding to the webpage to identify any HTML elements associated with (e.g., including, referencing, or tagged with) a security attribute. In some aspects, a security attribute may represent (or include) at least one security requirement that must be satisfied in order for a content element (of an HTML element that corresponds to the security attribute) to be outputted to the display 115 via a secure display path module 114. In some embodiments, the at least one security requirement may represent a function (or capability) of the secure display path module 114 or a security level. Further, the browser module 112 may be configured to load, render, and output the webpage (or one or more content elements of the webpage that do not represent sensitive information) to the display 115 directly (e.g., without using the secure display path module 114). The browser module 112 may also be configured to output the webpage (or one or more content elements of the webpage that may or may not represent sensitive information) to the display 115 indirectly (e.g., via the secure display path module 114).

In some embodiments, the operating system module 113 may include one or more operating systems. In some aspects, an operating system may represent software configured to (i) manage hardware and software resources of the user device 110 or (ii) provide services for applications associated with the user device 110. As shown in FIG. 1, in some embodiments, the operating system module 113 may include the secure display path module 114 (also referred to herein as the “secure display path 114”). In some aspects, the secure display path 114 may represent (or include) one or more technologies or functions used to protect data that the operating system module 113 receives from the browser module 112, and that may then be loaded, rendered, and output to the display 115, and presented on the display 115. Further, the secure display path 114 may be native (or specific) to a respective operating system of the operating system module 113. In some embodiments, the secure display path 114 may represent Microsoft's Protected Media Path, for example. In some aspects, the secure display path 114 may be configured to receive one or more content elements (or an entire webpage, website, portal, etc.) from the browser module 112.

Further, the secure display path 114 may be enabled when the operating system module 113 (or an operating system thereof) supports (or includes) the secure display path 114. In some embodiments, the secure display path 114 may be enabled when (i) the operating system module 113 (or an operating system thereof) supports the secure display path 114 and (ii) the secure display path 114 is configured in accordance with (or configured to satisfy) one or more security requirements of one or more security attributes. For example, the secure display path 114 may be enabled when the operating system module 113 supports the secure display path 114 and when one or more of the following security requirements of an example security attribute are satisfied: (i) the secure display path 114 is configured to block (e.g., prevent) one or more content elements from being transmitted to one or more external ports (e.g., a port for receiving a printer, a Universal Serial Bus device, a loud speaker, etc.) of the user device 110; (ii) the secure display path 114 is configured to block (e.g., prevent) one or more content elements from being transmitted to one or more loud speakers associated with (e.g., included in) the user device 110; (iii) the secure display path 114 is configured to block one or more content elements from being loaded, rendered, or output to the display 115 when a remote desktop application is operating on the user device 110 (e.g., to share the screen of the display 115); (iv) the secure display path 114 is configured to block one or more content elements from being loaded, rendered, or output to the display 115 when the display 115 is being screenshared (e.g., using a screensharing application, video conferencing application, etc.); or (v) the secure display path 114 is configured to block one or more content elements from being loaded, rendered, or output to the display 115 when the display 115 is being screenshotted. In some aspects, when the secure display path 114 is enabled, the secure display path 114 may be configured to load, render, or output one or more contents (or an entire webpage, website, portal, etc.) to the display 115 for presentation.

Further, when the secure display path 114 outputs each of one or more content elements that include sensitive information to the display 115, the secure display path 114 may protect each of the one or more content elements from potential social engineering by, for example, preventing each of the one or more content elements from being presented on the display 115 in response to determining that the display is being screenshared or screenshotted, or preventing each of the one or more content elements from being transmitted to (a) one or more external ports of the user device 110 or (b) one or more loud speakers included in the user device 110.

In some embodiments, the secure display path 114 may not be enabled (or be disabled) when the operating system module 113 (or an operating system thereof) does not support the secure display path 114. In some embodiments, the secure display path 114 may not be enabled (or be disabled) when the operating system module 113 (or an operating system thereof) supports the secure display path 114 but the secure display path 114 is not configured in accordance with (or not configured to satisfy) one or more security requirements associated with one or more security attributes. When the secure display path 114 is not enabled, the secure display path 114 may not receive one or content elements (or an entire webpage, website, portal, etc.) from the browser module 112 or may not load, render, or output one or more content elements (e.g., with associated security attributes) to the display 115 for display. In some embodiments, when the secure display path 114 is not enabled, the browser module 112 may be configured to not load, render, or output one or more content elements that are tagged as representing sensitive information or associated with a security attribute. However, in such embodiments, the browser module 112 may be configured to load, render, or output alt text (e.g., alternative text included in one or more HTML elements), where the alt text corresponds to the one or more content elements tagged as representing sensitive information or associated with security attribute(s).

In some embodiments, the user device 110 may be configured to (i) determine whether one or more content elements transmitted from the browser module 112 to the secure display path 114 were presented (or displayed) on the display 115, and (ii) transmit this determination to the application server 125. For example, subsequent (or responsive) to the browser module 112 transmitting one or more content elements to the secure display path 114 for display on the display 115 (and optionally the secure display path 114 transmitting the one or more content elements to the display 115), the operating system module 113 may transmit a notification to the secure display path 114, requesting that the secure display path 114 (or triggering the secure display path 114 to) determine whether any or all of the one or more content elements were displayed on the display 115. In response to receiving the notification (or trigger), the secure display path 114 may determine whether any or all of the one or more content elements were displayed on the display 115. The secure display path 114 may further transmit this determination to the browser module 112, which may transmit the determination to the application server 125 (e.g., via the network 120). Subsequently, the application server 125 may receive the determination regarding whether any or all of the one or more content elements were displayed on the display 115. In some embodiments, the application server 125, or a business or entity (or software developer) associated with the application server 125, may use the determination to analyze whether any or all of the one or more content elements were properly displayed (e.g., where screensharing or screenshotting was not detected), or properly blocked from being displayed (e.g., where screensharing or screenshotting was detected), on the display 115.

The application server 125 may be a computing system such as a server, a workstation, a desktop computer, a laptop, a mobile device, a tablet, etc. In some examples, the application server 125 may be associated with (or include) a cloud computing platform with scalable resources for computation or data storage. The application server 125 may run one or more applications locally or using the cloud computing platform, to perform various computer-implemented methods described in this disclosure. In some embodiments, the application server 125 may be associated with (e.g., owned, rented, or controlled by) a company, a business, or an organization, such as a bank, a hospital, a university, or a merchant, etc.

In some aspects, the application server 125 may be configured to communicate with the user device 110 via the network 120. For example, the application server 125 may be configured to transmit an HTML page (or file) corresponding to a webpage to the browser module 112 via the network 120. Further, the application server 125 may be configured to automatically (e.g., using a machine learning model, etc.) generate, store, manage, modify, interact with, transmit, or receive a webpage, an HTML page (e.g., including one or more HTML elements, etc.), a website, a web application, a portal, or an application, etc. In addition or in the alternative, a software developer (e.g., associated with a company, a business, or an organization that controls the application server 125) may use the application server 125 to generate, store, manage, modify, interact with, transmit, or receive a webpage, an HTML page (e.g., including one or more HTML elements, etc.), a website, a web application, a portal, or an application, etc. For example, a software developer may use the application server 125 to tag (e.g., flag or mark) one or more content elements of an HTML page corresponding to a webpage, to indicate that the one or more content elements include (or reference) sensitive information. In addition or in the alternative, a software developer may use the application server 125 to associate a security attribute (or a tag, flag or mark) with one or more content elements of an HTML page corresponding to a webpage, to indicate that the one or more content elements are subject to one or more security requirements that must be satisfied in order for the one or more content elements to be displayed by the display 115. Put differently, a software developer may use the application server 125 to tag, or associate security attribute(s) with, one or more content elements of an HTML page to control which content elements of the HTML page may be transmitted from the browser module 112 to the display 115 via the secure display path 114.

In various embodiments, the network 120 may be a wide area network (“WAN”), a local area network (“LAN”), personal area network (“PAN”), or the like. In some embodiments, network 120 may include the Internet, and support the transmission of information and data between various systems online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” or “webpage” generally encompasses a location, data store, or the like that is, for example, hosted or operated by a computer system so as to be accessible online, and that may include data configured to cause a program such as a browser to perform operations such as send, receive, or process data, generate a visual display or an interactive interface, or the like

Although depicted as separate components in FIG. 1, it should be understood that a component or portion of a component in the environment 100 may, in some embodiments, be integrated with or incorporated into one or more other components. For example, in some embodiments, at least a portion of the application server 125 may be integrated into the user device 110. In some embodiments, operations or aspects of one or more of the components discussed above may be distributed amongst one or more other components. Any suitable arrangement or integration of the various systems and devices of the environment 100 may be used. Further, in some embodiments, the environment 100 may include multiple user devices 110 or multiple application servers 125.

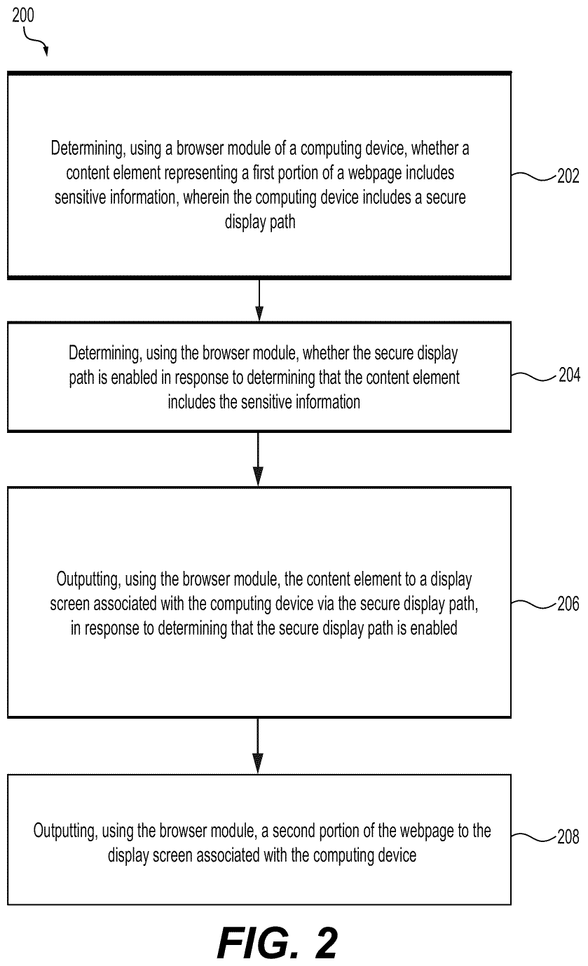

FIG. 2 is a flowchart illustrating a method 200 for securing content (e.g., one or more content elements) of a webpage displayed on a display screen, according to one or more embodiments of the present disclosure. In some aspects, the method 200 may be performed by the user device 110 of FIG. 1.

As shown in FIG. 2, the method 200 may include determining, using a browser module (e.g., the browser module 112) of a computing device (e.g., the user device 110), whether a content element representing a first portion of a webpage includes sensitive information, where the computing device includes a secure display path (e.g., the secure display path 114) (202). In some aspects, the secure display path may be included in an operating system (e.g., of the operating system module 113) of the computing device. In some embodiments, determining whether the content element includes sensitive information may include determining whether the content element is associated with a tag. In some embodiments, the content element may have been tagged (or marked) by a software developer using (or associated with) an application server (e.g., the application server 125). Further, in some embodiments, determining whether the content element includes the sensitive information may include determining whether the content element is associated with a security attribute. In some embodiments, the content element may have been associated with a security attribute by a software developer using (or associated with) the application server. The security attribute may include at least one security requirement for the content element to be presented on a display screen (e.g., the display 115) via the secure display path. Further, the at least one security requirement may include one or more of the following: (i) the secure display path is configured to block the content element from being transmitted to one or more external ports of the computing device; (ii) the secure display path is configured to block the content element from being transmitted to one or more loud speakers included in the computing device; (iii) the secure display path is configured to block the content element from being presented on the display screen when a remote desktop application is operating on the computing device; (iv) the secure display path is configured to block the content element from being presented on the display screen when the display screen is being screenshared; or (v) the secure display path is configured to block the content element from being presented on the display screen when the display screen is being screenshotted.

As shown in FIG. 2, the method 200 may include determining, using the browser module, whether the secure display path is enabled in response to determining that the content element includes the sensitive information (204). In some embodiments, determining that the secure display path is enabled may include determining the at least one security requirement is satisfied.

In some embodiments, the method 200 may further include outputting, using the browser module, the content element to a display screen associated with the computing device via the secure display path, in response to determining that the secure display path is enabled (206). In some other embodiments, the method 200 may include transmitting, using the browser module, the content element (and optionally the tag or security attribute associated with the content element) to the secure display path, which may transmit (or output) the content element to the display screen (e.g., responsive to the browser module determining that the secure display path is enabled). In some aspects, the secure display path may be configured to determine whether the display screen is being screenshared or screenshotted. The secure display path may also be configured to, upon determining that the display screen is being screenshared or screenshotted, block the content element from being displayed on the display screen.

In some embodiments, the method 200 may include outputting, using the browser module, a second portion of the webpage (e.g., a portion of the webpage not including sensitive information) to the display screen associated with the computing device (208). In some embodiments, prior to outputting the content element to the display screen via the secure display path in response to determining that the secure display path is enabled, the content element is not decrypted by a content decryption module associated with a digital rights management technology. Further, in some embodiments, outputting, using the browser module, the second portion of the webpage to the display screen may include outputting the second portion of the webpage to the display screen via the secure display path.

Further, in some embodiments, the method 200 may include determining, using the browser module, that the secure display path is not enabled. For example, the secure display path may not be enabled when the operating system does not support (e.g., cannot implement) the secure display path. As another example, the secure display path may not be enabled when the at least one security requirement is not satisfied. In some embodiments, in response to determining that the content element includes sensitive information and that secure display path is not enabled, the method 200 may include blocking, using the browser module, the content element from being outputted to the display screen. Further, in response to determining that the content element includes sensitive information and that secure display path is not enabled, the method 200 may include outputting, using the browser module, alt text associated with the content element to the display screen.

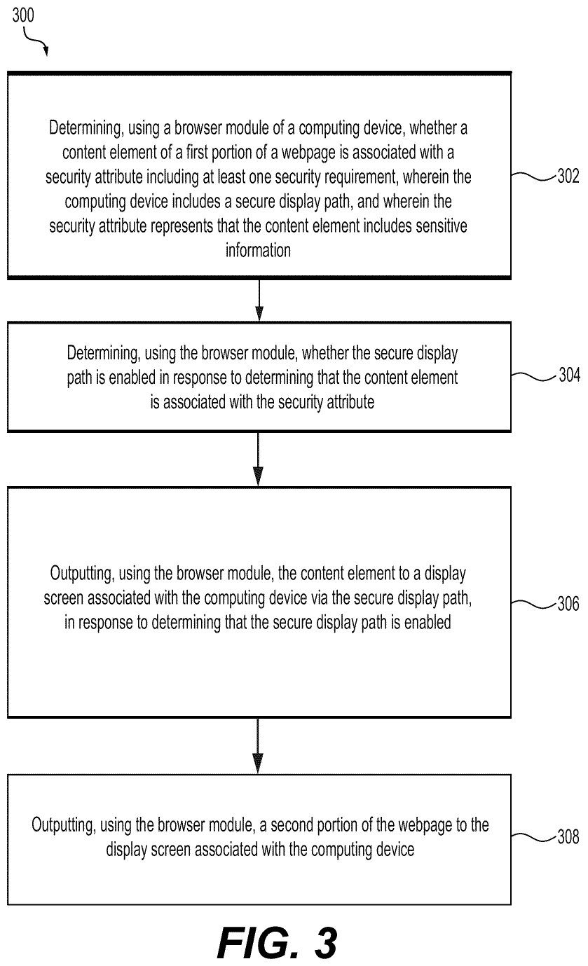

FIG. 3 is a flowchart illustrating a method 300 for securing content (e.g., one or more content elements) of a webpage displayed on a display screen, according to one or more embodiments of the present disclosure. In some embodiments, the method 300 may be performed by the user device 110 of FIG. 1. Further, the method 300 may be an embodiment of the method 200 of FIG. 2.

The method 300 may include determining, using a browser module (e.g., the browser module 112) of a computing device (e.g., the user device 110), whether a content element of a first portion of a webpage is associated with a security attribute including at least one security requirement, wherein the computing device includes a secure display path (e.g., the secure display path 114), and wherein the security attribute represents that the content element includes sensitive information (302). In some embodiments, the content element may have been associated with the security attribute by a software developer using (or associated with) an application server (e.g., the application server 125). The method 300 may include determining, using the browser module, whether the secure display path is enabled in response to determining that the content element is associated with the security attribute (304). The method 300 may include outputting, using the browser module, the content element to a display screen associated with the computing device via the secure display path, in response to determining that the secure display path is enabled (306). The method 300 may further include outputting, using the browser module, a second portion of the webpage to the display screen associated with the computing device (308).

In general, any process or operation discussed in this disclosure that is understood to be computer-implementable, such as the processes (or methods) illustrated in FIGS. 2 and 3, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

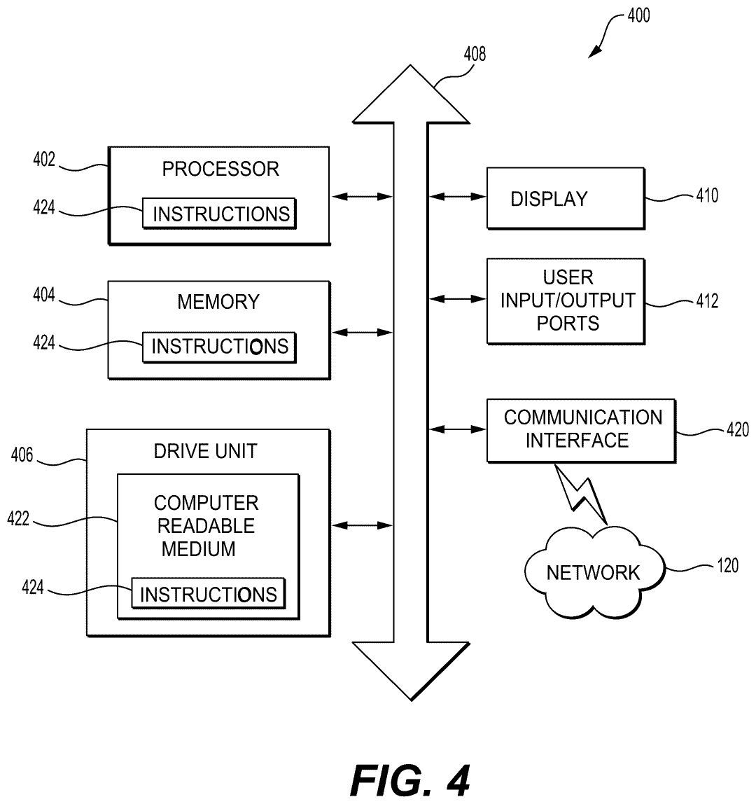

FIG. 4 is a simplified functional block diagram of a computer 400 that may be configured as a device for executing the methods of FIG. 2 or 3, according to exemplary embodiments of the present disclosure. For example, in some embodiments, the computer 400 may be configured as the user device 110, according to exemplary embodiments of this disclosure. In some other embodiments, the computer 400 may be configured as the application server 125, according to exemplary embodiments of this disclosure. In various embodiments, any of the devices or systems herein may be a computer 400 including, for example, a data communication interface 420 for packet data communication. The computer 400 also may include a central processing unit (“CPU”) 402, in the form of one or more processors, for executing program instructions. The computer 400 may include an internal communication bus 408, and a storage (or drive) unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 or computer readable medium 422). The computer 400 also may include input and output ports 412 or a display (or display screen) 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method comprising:
determining, using a browser module of a computing device, whether a content element representing a first portion of a webpage includes sensitive information, wherein the computing device includes a secure display path;
determining, using the browser module, whether the secure display path is enabled in response to determining that the content element includes the sensitive information;
outputting, using the browser module, the content element to a display screen associated with the computing device via the secure display path, in response to determining that the secure display path is enabled; and
outputting, using the browser module, a second portion of the webpage to the display screen associated with the computing device.

2. The method of claim 1, wherein the secure display path is included in an operating system of the computing device.

3. The method of claim 1, wherein determining, using the browser module of the computing device, whether the content element representing the first portion of the webpage includes the sensitive information comprises:
determining whether the content element is associated with a security attribute.

4. The method of claim 3, wherein the security attribute includes at least one security requirement for the content element to be presented on the display screen via the secure display path.

5. The method of claim 4, wherein the at least one security requirement includes one or more of:
the secure display path is configured to block the content element from being transmitted to one or more external ports of the computing device;
the secure display path is configured to block the content element from being transmitted to one or more loud speakers included in the computing device;
the secure display path is configured to block the content element from being presented on the display screen when a remote desktop application is operating on the computing device;
the secure display path is configured to block the content element from being presented on the display screen when the display screen is being screenshared; or
the secure display path is configured to block the content element from being presented on the display screen when the display screen is being screenshotted.

6. The method of claim 5, wherein determining that the secure display path is enabled includes determining that the at least one security requirement is satisfied.

7. The method of claim 1, wherein outputting, using the browser module, the second portion of the webpage to the display screen comprises:
outputting the second portion of the webpage to the display screen via the secure display path.

8. The method of claim 1, further comprising:
blocking, using the browser module, the content element from being outputted to the display screen in response to determining that the secure display path is not enabled.

9. The method of claim 8, wherein determining, using the browser module of the computing device, whether the content element representing the first portion of the webpage includes the sensitive information comprises:
determining that the content element is associated with a security attribute including one or more security requirements, wherein the secure display path is not enabled when one or more of the one or more security requirements are not satisfied.

10. The method of claim 9, further comprising:
outputting, using the browser module, alt text associated with the content element to the display screen in response to determining that the secure display path is not enabled.

11. The method of claim 1, wherein prior to outputting the content element to the display screen via the secure display path in response to determining that the secure display path is enabled, the content element is not decrypted by a content decryption module associated with digital rights management.

12. The method of claim 11, wherein determining, using the browser module, whether the content element representing the first portion of the webpage includes the sensitive information comprises:
determining whether the content element is associated with a tag.

13. The method of claim 1, further comprising:
responsive to outputting the content element to the display screen, determining, using the secure display path, whether the content element was displayed on the display screen; and
transmitting, using the secure display path, the determination whether the content element was displayed on the display screen, to the browser module.

14. A system, comprising:
a processor; and
a memory having programming instructions stored thereon, which, when executed by the processor, causes the system to perform operations comprising:
determining, using a browser module of a computing device, whether a content element representing a first portion of a webpage includes sensitive information, wherein the computing device includes a secure display path;
determining, using the browser module, whether the secure display path is enabled in response to determining that the content element includes the sensitive information;
outputting, using the browser module, the content element to a display screen associated with the computing device via the secure display path, in response to determining that the secure display path is enabled; and
outputting, using the browser module, a second portion of the webpage to the display screen associated with the computing device.

15. The system of claim 14, wherein the secure display path is included in an operating system of the computing device.

16. The system of claim 14, wherein determining, using the browser module of the computing device, whether the content element representing the first portion of the webpage includes the sensitive information comprises:
determining whether the content element is associated with a security attribute.

17. The system of claim 16, wherein the security attribute includes at least one security requirement for the content element to be presented on the display screen via the secure display path.

18. The system of claim 17, wherein the at least one security requirement includes one or more of:
the secure display path is configured to block the content element from being transmitted to one or more external ports of the computing device;
the secure display path is configured to block the content element from being transmitted to one or more loud speakers included in the computing device;
the secure display path is configured to block the content element from being presented on the display screen when a remote desktop application is operating on the computing device;
the secure display path is configured to block the content element from being presented on the display screen when the display screen is being screenshared; or
the secure display path is configured to block the content element from being presented on the display screen when the display screen is being screenshotted.

19. The system of claim 18, wherein determining that the secure display path is enabled includes determining that the at least one security requirement is satisfied.

20. A method comprising:
determining, using a browser module of a computing device, whether a content element of a first portion of a webpage is associated with a security attribute including at least one security requirement, wherein the computing device includes a secure display path, and wherein the security attribute represents that the content element includes sensitive information;
determining, using the browser module, whether the secure display path is enabled in response to determining that the content element is associated with the security attribute;
outputting, using the browser module, the content element to a display screen associated with the computing device via the secure display path, in response to determining that the secure display path is enabled; and
outputting, using the browser module, a second portion of the webpage to the display screen associated with the computing device.
